(19) United States
(12) Patent Application Publication
(10) Pub. No.: US 2025/0296751 A1
(43) Pub. Date: Sep. 25, 2025

(54) ARTICLE SUITABLE FOR FOOD CONTACT AND METHOD FOR PRODUCING SAME

(71) Applicant: Elkem Silicones France SAS, Lyon (FR)

(72) Inventors: Gwenael LUSSEAU, Lyon (FR); Sebastien PERINET, Lyon (FR); Agnes JOLLY, Lyon (FR); Myriam SLAVIERO, Lyon (FR); Arnaud PONCE, Lyon (FR)

(21) Appl. No.: 18/861,903

(22) PCT Filed: May 2, 2023
(86) PCT No.: PCT/FR2023/000072

§ 371 Date: Oct. 31, 2024

(30) Foreign Application Priority Data
May 3, 2022 (FR) FR2204179

(51) Int. Cl. B65D 65/40; B32B 7/12; B32B 29/00; B32B 37/12; B32B 37/24; C09D 5/16; C09D 183/04; C09J 5/00; C09J 183/04

(52) U.S. Cl. CPC B65D 65/40; B32B 7/12; B32B 29/005; B32B 37/12; B32B 37/24; C09D 5/1675; C09D 183/04; C09J 5/00; C09J 183/04; B32B 2037/243; B32B 2255/12; B32B 2255/26; B32B 2317/12; B32B 2439/40; B32B 2439/70; C09J 2400/286; C09J 2483/008

(57) ABSTRACT

An article suitable for food contact includes a first substrate and a second substrate which are joined by an adhesive, said first substrate including a support coated with a silicone coating suitable for food contact, said adhesive being inserted between the two substrates and being in contact with the silicone coating of said first substrate. Said adhesive is a structural silicone adhesive suitable for food contact and obtained by crosslinking a silicone composition which is crosslinkable by a polyaddition reaction.

### TECHNICAL FIELD

The present invention relates to the field of food packaging, and more specifically silicone substrate-based food packaging.

### PRIOR ART

Faced with changes in regulations aiming to limit the use of single-use plastics, the industry is seeking alternatives to food packaging which typically consists of paper coated with a polyolefinic coating. In this context, there is a need to propose coated paper solutions which have water barrier properties and are capable of withstanding large temperature ranges, particularly in the field of packaging suitable for food contact.

In order to meet this need, it can be envisaged to use silicone papers, which are typically used in pastry making and are commonly referred to as baking parchment or greaseproof paper. These papers consist of a (cellulose-based) paper base having specific porosity and roughness properties and having a grammage of approximately 40 g/m², and also a thin layer of silicone coated on one or both faces of this paper and having a thickness of between 0.1 μm and 1 μm. These silicone papers are suitable for food contact. They are non-stick and water-repellent: food does not stick to its packaging even after a period of storage of a year or more, at temperatures which may be as low as −30° C., or even as low as −70° C. They are also able to withstand, without breaking down, the stresses of rapid cooking techniques for frozen food (temperature of around 300° C. in microwave ovens, steam cooking). They are therefore suitable candidates for manufacturing food packaging.

The manufacture of food packaging involves one or more assembly steps to produce the sides and the bottom of a bag, for example. In the case of papers coated with a polyolefinic coating, these assembly steps can be performed either using an adhesive or by a step of fusion welding the surface plastic layer.

In this context, one difficulty in using a silicone paper for manufacturing food packaging lies in the step of adhesive bonding on the silicone face(s).

This problem has been described, for example, in the Japanese patent application JP H05-319461. This document describes the manufacture of a bag for packaging food, consisting of a silicone paper and a silicone adhesive, making it possible to form a leaktight seal. Said silicone adhesive is a PSA (pressure-sensitive adhesive) consisting of silicone rubber and resin.

Tests have shown that choosing a PSA as silicone adhesive did not make it possible to obtain satisfactory adhesive bonding and is not suitable for food packaging.

Similarly, the document KR20150057550 discloses a food packaging comprising a silicone adhesive. However, this silicone adhesive is a composition which is crosslinkable by polycondensation, releasing acetic acid. This type of composition is illustrated as a comparative example in the context of the present invention, and has the disadvantage of an unpleasant acetic acid odor for the consumer and during the adhesive bonding step. Moreover, the presence of acetic acid may present health and safety concerns for operators.

### SUMMARY OF THE INVENTION

In this context, a subject of the present invention is an article suitable for food contact, particularly a food packaging, which preferably meets the following needs: it is desired to have an article which does not comprise a petroleum-based polymeric coating, which is capable of withstanding large temperature ranges, which has water barrier properties, which is leaktight, particularly in the assembly regions, and which can be manufactured at a high throughput, preferably using standard industrial equipment from the packaging field.

In order to meet these needs, the article suitable for food contact according to the present invention comprises a first substrate and a second substrate which are joined by an adhesive, said first substrate comprising a support coated with a silicone coating suitable for food contact, said adhesive being inserted between the two substrates and being in contact with the silicone coating of said first substrate, characterized in that said adhesive is a structural silicone adhesive suitable for food contact and obtained by crosslinking a silicone composition which is crosslinkable by a polyaddition reaction.

Another subject of the invention is a method for manufacturing an article suitable for food contact, said method comprising the steps consisting in:
providing a first substrate and a second substrate, the first substrate comprising a support coated with a silicone coating suitable for food contact,
depositing, on the silicone coating of said first substrate, a silicone composition which is crosslinkable by a polyaddition reaction and is suitable for food contact,
joining the second substrate and the first substrate together such that said silicone composition is between the two substrates,
causing or allowing said silicone composition to crosslink in order to adhesively bond the two substrates by a structural silicone adhesive.

Finally, another subject of the invention is the use of a structural silicone adhesive, suitable for food contact and obtained by crosslinking a silicone composition which is crosslinkable by a polyaddition reaction, in order to manufacture an article suitable for food contact.

### DETAILED DESCRIPTION OF THE INVENTION

Unless otherwise indicated, all the viscosities of the silicone oils referred to in the present disclosure correspond to a “Newtonian” dynamic viscosity at 25° C., i.e. the dynamic viscosity which is measured in a manner known per se with a Brookfield viscometer having a shear rate gradient which is sufficiently low for the viscosity measured to be independent of the rate gradient.

A subject of the present invention is therefore an article suitable for food contact comprising a first substrate and a second substrate which are joined by an adhesive. Said adhesive is a structural silicone adhesive.

For the purpose of the present text, an adhesive can be termed “structural” when said adhesive is not the weak point in said assembly.

It is important to note that the structural silicone adhesive as defined in the present invention is not a PSA (pressure-sensitive adhesive). A PSA forms a bond with a substrate simply by contact or by applying light pressure in order to join the adhesive with the surface of the substrate. Physical bonds are created because the PSA adhesive is soft enough to wet the surface of the substrate, but also hard enough not to flow when pressure is applied to the adhesive bonding area. When the adhesive and the surface of the substrate are close, van der Waals-type molecular interactions may make a significant contribution to the bond strength. A PSA therefore forms a physical, not chemical, bond with the surface of the substrate. A chemical bond can be defined as a bond between reactive chemical groups at the adhesive-substrate interface. In contrast, a physical bond can be defined as a temporary or reversible non-chemical bond created by a physical interaction between the adhesive and the substrate. Silicone PSA compositions generally consists of a hydroxylated silicone resin of the MQ(OH) type and a linear silicone rubber in solution in an organic solvent, typically toluene and/or xylene.

In contrast, without however wishing to be bound by this theory, the structural silicone adhesive according to the present invention, which is not a PSA, can form a chemical bond with the substrate and thus can ensure good adhesion between two substrates. Preferably, the failure between the two substrates assembled using the structural silicone adhesive according to the present invention is cohesive failure. In the present text, the expression “cohesive failure” means a failure occurring within the body of the material, as opposed to “adhesive failure” which occurs at the interface between the adhesive and the substrate.

The silicone adhesive according to the present invention must be suitable for food contact. An object being suitable for food contact in the field of food packaging means that the material of which it consists meets regulatory requirements or standards ensuring that this object does not cause any risk of toxicity for food or beverages.

In Europe, reference may be made to regulation (EC) 1935/2004 which sets general guidelines for all materials intended to come into contact with foodstuffs. More specifically, the recommendations of the BfR in Germany, or Title 21 of the CFR produced by the FDA in the USA, can be taken into consideration.

Under normal conditions of use, the materials used must not release constituents into the food in amounts which are liable to present a risk to human health or to lead to an unacceptable alteration to the composition of the foodstuffs, with or without adversely affecting the organoleptic qualities of these foodstuffs.

The silicone adhesive according to the present invention, which is not a PSA, is obtained by crosslinking a silicone composition which is crosslinkable by a polyaddition reaction. Preferably, the silicone composition which is crosslinkable by a polyaddition reaction comprises:
at least one polyorganosiloxane A having, per molecule, at least two C₂-C₁₂ alkenyl groups bonded to the silicon,
at least one polyorganosiloxane B having, per molecule, at least two SiH units,
a catalytically effective amount of at least one polyaddition catalyst C, preferably a platinum-based polyaddition catalyst, and
optionally at least one crosslinking inhibitor D.

The polyorganosiloxane A having, per molecule, at least two C₂-C₁₂ alkenyl groups bonded to the silicon, can preferably be a linear polyorganosiloxane formed of:
at least two siloxyl units of the following formula: YₐR¹_{b}SiO_{(4-a-b)/2}
   wherein Y represents a C₂-C₁₂ alkenyl group, preferably a vinyl group: R¹ represents a monovalent hydrocarbon group having from 1 to 12 carbon atoms, preferably selected from alkyl groups having from 1 to 8 carbon atoms, such as methyl, ethyl, propyl groups, cycloalkyl groups having from 3 to 8 carbon atoms and aryl groups having from 6 to 12 carbon atoms; a=1 or 2, b=0, 1 or 2 and the sum a+b=2 or 3, and
optionally units of the following formula: R¹_{c}SiO_{(4-c)/2}
   wherein R¹ has the same meaning as above and c=2 or 3.

It is understood in the formulas above that, if several R¹ groups are present, they may be identical to or different from one another.

Preferably, said polyorganosiloxanes A are oils having a dynamic viscosity of between 100 mPa·s and 100 000 mPa·s, preferably between 1000 mPa·s and 100 000 mPa·s. According to a preferred embodiment, the silicone composition according to the present invention does not comprise any linear silicone rubber.

The polyorganosiloxane A having, per molecule, at least two C₂-C₁₂ alkenyl groups bonded to the silicon may preferably essentially consist of siloxyl units “D” selected from the group consisting of the siloxyl units R¹₂SiO_{2/2}, YR¹SiO_{2/2} and Y₂SiO_{2/2}, and of terminal siloxyl units “M” selected from the group consisting of the siloxyl units YR¹₂SiO_{1/2}, Y₂R¹SiO_{1/2} and R¹₃SiO_{1/2}. The symbols Y and R¹ are as described above.

As examples of terminal units “M”, mention may be made of trimethylsiloxy, dimethylphenylsiloxy, dimethylvinylsiloxy or dimethylhexenylsiloxy groups.

As examples of units “D”, mention may be made of dimethylsiloxy, methylphenylsiloxy, methylvinylsiloxy, methylbutenylsiloxy, methylhexenylsiloxy, methyldecenylsiloxy or methyldecadienylsiloxy groups.

Examples of linear polyorganosiloxanes which may be a polyorganosiloxane A according to the invention are:
a poly(dimethylsiloxane) having dimethylvinylsilyl ends;
a poly(dimethylsiloxane-co-methylphenylsiloxane) having dimethylvinylsilyl ends;
a poly(dimethylsiloxane-co-methylvinylsiloxane) having dimethylvinylsilyl ends; and
a poly(dimethylsiloxane-co-methylvinylsiloxane) having trimethylsilyl ends.

Preferably, the polyorganosiloxane A contains terminal dimethylvinylsilyl units and, even more preferentially, the polyorganosiloxane A is a poly(dimethylsiloxane) having dimethylvinylsilyl ends.

Preferably, the polyorganosiloxane A has a content by weight of alkenyl units of between 0.001% and 30%, preferably between 0.01% and 10%, preferably between 0.02% and 5%.

The silicone composition preferably comprises from 50% to 95% by weight of polyorganosiloxane A, even more preferentially from 60% to 90% by weight of polyorganosiloxane A.

According to one embodiment, it is possible for the silicone composition according to the present invention to contain a branched polyorganosiloxane or resin comprising C₂-C₁₂ alkenyl units. Branched polyorganosiloxanes, also referred to as resins, contain siloxyl units “T” (R¹SiO_{3/2}) and/or siloxyl units “Q” (SiO_{4/2}). The symbols R¹ are as described above. Examples of branched polyorganosiloxanes are:
a poly(dimethylsiloxane)(methylsiloxane) having trimethylsilyl and dimethylvinylsilyl ends, consisting of trimethylsiloxy units “M”, dimethylvinylsiloxy units “M”, dimethylsiloxy units “D” and methylsiloxy units “T”;
a resin consisting of trimethylsiloxy units “M”, dimethylvinylsiloxy units “M”, and “Q”; and
a resin consisting of trimethylsiloxy units “M”, methylvinylsiloxy units “D”, and “Q”.

Nevertheless, according to a preferred embodiment, the silicone composition does not comprise any branched polyorganosiloxanes or resins comprising C₂-C₁₂ alkenyl units.

The polyorganosiloxane B is a polyorganosiloxane having, per molecule, at least two SiH units. This is therefore a polyorganohydrogensiloxane. Preferably, the compound B comprises at least three SiH units.

According to a preferred embodiment, the silicone composition of the invention comprises one or more polyorganosiloxane(s) B as a mixture.

According to a preferred embodiment, the silicone composition according to the invention comprises at least one polyorganosiloxane having, per molecule, two SiH units, and at least one polyorganosiloxane having, per molecule, three or more SiH units.

According to one embodiment of the invention, the silicone composition comprises at least one linear polyorganosiloxane B having, per molecule, at least two SiH units, and a polyorganosiloxane B having a branched structure, such as a silicone resin.

The polyorganosiloxane B may advantageously be a polyorganosiloxane comprising at least two, preferably at least three, siloxyl units of the following formula: H_{d}R²ₑSiO_{(4-d-e)/2}
wherein R² represents a monovalent radical having from 1 to 12 carbon atoms, d=1 or 2, e=0, 1 or 2 and d+e=1, 2 or 3;
and optionally other units of the following formula: R²_{f}SiO_{(4-f)/2}
wherein R² has the same meaning as above, and f=0, 1, 2, or 3.

It is understood that, if several R² groups are present in the formulas above, they may be identical to or different from one another.

Preferentially, R² may represent a monovalent radical selected from the group consisting of alkyl groups having from 1 to 8 carbon atoms, optionally substituted with at least one halogen atom such as chlorine or fluorine, cycloalkyl groups having from 3 to 8 carbon atoms, and aryl groups having from 6 to 12 carbon atoms. R² may advantageously be selected from the group consisting of methyl, ethyl, propyl, 3,3,3-trifluoropropyl, xylyl, tolyl and phenyl.

The symbol d is preferentially equal to 1.

The polyorganosiloxane B may have a linear, branched or cyclic structure. The degree of polymerization is preferably greater than or equal to 2. Generally, it is less than 5000. Preferably, the viscosity of the polyorganosiloxane B is between 1 mPa·s and 5000 mPa·s, more preferentially between 1 mPa·s and 2000 mPa·s, and even more preferentially between 5 mPa·s and 1000 mPa·s.

In the case of linear polymers, they essentially consist of siloxyl units “D” selected from the units R²₂SiO_{2/2} and R²HSiO_{2/2}, and of terminal siloxyl units “M” selected from the units R²₃SiO_{1/2} and R²₂HSiO_{1/2}, in which R² has the same meaning as above.

Examples of linear polyorganohydrogensiloxanes which may be compounds B according to the invention are:
a poly(dimethylsiloxane) having hydrogendimethylsilyl ends;
a poly(dimethylsiloxane-co-methylhydrogensiloxane) having trimethylsilyl ends;
a poly(dimethylsiloxane-co-methylhydrogensiloxane) having hydrogendimethylsilyl ends;
a poly(methylhydrogensiloxane) having trimethylsilyl ends; and
a cyclic poly(methylhydrogensiloxane).

In one embodiment, the polyorganosiloxane B of the silicone composition according to the invention comprises a linear polyorganohydrogensiloxane or a plurality of linear polyorganohydrogensiloxanes as a mixture.

In one embodiment, the polyorganosiloxane B of the silicone composition according to the invention comprises a polyorganohydrogensiloxane B which is a poly(dimethylsiloxane-co-methylhydrogensiloxane) having hydrogendimethylsilyl ends and a polyorganohydrogensiloxane B which is a poly(methylhydrogensiloxane) having trimethylsilyl ends.

When the polyorganohydrogensiloxane B has a branched structure, it is preferably selected from the group consisting of the silicone resins of the following formulas:
M′Q in which the hydrogen atoms bonded to silicon atoms are borne by the groups M;
MM′Q in which the hydrogen atoms bonded to silicon atoms are borne by some of the units M;
MD′Q in which the hydrogen atoms bonded to silicon atoms are borne by the groups D;
MDD′Q in which the hydrogen atoms bonded to silicon atoms are borne by some of the groups D;
MM′TQ in which the hydrogen atoms bonded to silicon atoms are borne by some of the units M;
MM′DD′Q in which the hydrogen atoms bonded to silicon atoms are borne by some of the units M and D;
and mixtures thereof,
   where M=siloxyl unit of formula R²₃SiO_{1/2}, M′=siloxyl unit of formula R²₂HSiO_{1/2}, D=siloxyl unit of formula R²₂SiO_{2/2}, D′=siloxyl unit of formula R²HSiO_{2/2}, T=siloxyl unit of formula R²₃SiO_{1/2} and Q=siloxyl unit of formula SiO_{4/2}, in which R² has the same meaning as above.

In one embodiment, the polyorganosiloxane B of the silicone composition according to the invention comprises one or more linear polyorganohydrogensiloxanes as a mixture, and a silicone resin.

In one embodiment, the polyorganosiloxane B of the silicone composition according to the invention comprises a polyorganohydrogensiloxane B which is a poly(dimethylsiloxane-co-methylhydrogensiloxane) having hydrogendimethylsilyl ends, a polyorganohydrogensiloxane B which is a poly(methylhydrogensiloxane) having trimethylsilyl ends, and a silicone resin.

Preferably, the polyorganosiloxane B has a content by weight of hydrosilyl Si—H functions of between 0.2% and 91%, more preferentially between 3% and 80%, and even more preferentially between 15% and 70%.

Advantageously, the molar ratio of the hydrosilyl Si—H functions of the polyorganosiloxanes B to the alkene functions of the polyorganosiloxanes A is between 0.01 and 20, preferably between 0.1 and 10, preferentially between 0.5 and 5, more preferentially between 1 and 5, and even more preferentially between 1 and 3.

The silicone composition according to the invention preferably comprises from 0.1% to 20% by weight, more preferentially from 0.1% to 10%, and even more preferentially from 0.5% to 5% by weight of polyorganosiloxane B.

The hydrosilylation catalyst C may particularly be selected from platinum and rhodium compounds but also from silicon compounds, such as those described in patent applications WO 2015/004396 and WO 2015/004397, germanium compounds such as those described in patent application WO 2016/075414, or nickel, cobalt or iron complexes such as those described in patent applications WO 2016/071651. WO 2016/071652 and WO 2016/071654. The catalyst C is preferably a compound derived from at least one metal belonging to the platinum group. These catalysts are well known. Use may in particular be made of complexes of platinum and an organic product described in patents U.S. Pat. Nos. 3,159,601, 3,159,602, 3,220,972 and European patents EP 0,057,459. EP 0,188,978 and EP 0,190,530, complexes of platinum and vinyl-containing organosiloxanes described in patents U.S. Pat. Nos. 3,419,593, 3,715,334, 3,377,432 and 3,814,730. Alternatively, a photoactivatable hydrosilylation catalyst may be used. Said catalyst may be activated by irradiation, in particular by UV radiation.

Preferentially, the catalyst C is a platinum-derived compound. In this case, the amount by weight of catalyst C, calculated by weight of platinum metal, is generally between 2 ppm and 400 ppm by mass, more preferably between 50 ppm and 300 ppm, and even more preferably between 70 ppm and 200 ppm, based on the total weight of the silicone composition. Alternatively, the amount by weight of catalyst C, calculated by weight of platinum metal, may be between 5 ppm and 200 ppm by mass, more preferably between 20 ppm and 200 ppm.

Preferentially, the catalyst C is a Karstedt platinum.

The silicone composition according to the invention may optionally contain a crosslinking inhibitor D. Crosslinking inhibitors are designed to slow the crosslinking reaction, and are also referred to as retarders. Crosslinking inhibitors are well known in the prior art. Mention may for example be made of the cyclic polymethylvinylsiloxanes and acetylenic alcohols described in patent U.S. Pat. No. 3,923,705, the acetylenic alcohols described in patent U.S. Pat. No. 3,445,420, the heterocyclic amines described in patent U.S. Pat. No. 3,188,299, the diallyl maleate and other dialkyl esters described in patent U.S. Pat. No. 4,256,870, the olefinic siloxanes described in patent U.S. Pat. No. 3,989,667, and the dialkyl ethynedicarboxylates described in patent U.S. Pat. No. 4,347,346. Mention may also be made of the following classes of inhibitors: hydrazines, triazoles, phosphines, mercaptans, organic nitrogen-based compounds, acetylenic alcohols, silylated acetylenic alcohols, maleates, fumarates, ethylenically unsaturated or aromatic amides, ethylenically unsaturated isocyanates, olefinic siloxanes, unsaturated hydrocarbon monoesters and diesters, conjugated ene-ynes, hydroperoxydes, nitriles and diaziridines. The crosslinking inhibitor D is preferably selected from 1,3,5,7-tetramethyl-1,3,5,7-tetravinyl-cyclotetrasiloxane, 1-ethynyl-1-cyclohexanol (ECH), 3-methyl-1-butyn-3-ol, 2-methyl-3-butyn-2-ol, 3-butyn-1-ol, 3-butyn-2-ol, propargyl alcohol, 2-phenyl-2-propyn-1-ol, 3,5-dimethyl-1-hexyn-3-ol, 1-ethynylcyclopentanol, 1-phenyl-2-propynol, 3-methyl-1-penten-4-yn-3-ol, 3-methyl-1-dodecyn-3-ol, 3,7,11-trimethyl-1-dodecyn-3-ol, diphenyl-1,1-propyn-2-ol-1,3,6-diethyl-1-nonyn-3-ol, 3-methyl-1-pentadecyn-3-ol, and mixtures thereof. Acetylenic alcohols are highly preferred crosslinking inhibitors D according to the invention, most particularly 1-ethynyl-1-cyclohexanol (ECH). According to one embodiment, the silicone composition D comprises between 1 ppm and 1000 ppm of crosslinking inhibitor D, preferably between 20 ppm and 500 ppm, relative to the total weight of the silicone composition.

The silicone composition which is crosslinkable by a polyaddition reaction may optionally comprise a filler. According to one embodiment, the silicone composition comprises between 5% and 40% by weight of filler relative to the total weight of the silicone composition. Advantageously, the silicone composition comprises between 10% and 30% by weight of filler.

The optionally provided filler is preferably mineral. The filler may be a very finely-divided product, the mean particle diameter of which is less than 0.1 μm. The filler may particularly be siliceous. Siliceous materials may serve as reinforcing or semi-reinforcing filler. Reinforcing siliceous fillers are selected from colloidal silicas, fumed and precipitated silica powders, and mixtures thereof. These powders generally have a mean particle size of less than 0.1 μm (micrometers) and a BET specific surface area of greater than 30 m²/g, preferably of between 30 m²/g and 350 m²/g. Semi-reinforcing siliceous fillers such as diatomaceous earths or ground quartz may also be used. These silicas may be incorporated as is, or after having been treated by organosilicon compounds conventionally used for this purpose. These compounds include the methylpolysiloxanes such as hexamethyldisiloxane, octamethylcyclotetrasiloxane, methylpolysilazanes such as hexamethyldisilazane, hexamethylcyclotrisilazane, tetramethyldivinyldisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane, and mixtures thereof. Non-siliceous mineral materials may be used as semi-reinforcing mineral filler or bulking filler. Examples of non-siliceous fillers which may be used alone or as a mixture include calcium carbonate, optionally surface-treated with an organic acid or an organic acid ester, calcined clay, rutile titanium oxide, oxides of iron, zinc, chromium, zirconium or magnesium, various forms of alumina (hydrated or unhydrated), boron nitride, lithopone, barium metaborate, barium sulfate and glass microbeads. These fillers are coarser, having a mean particle diameter of generally greater than 0.1 μm and a specific surface area of generally less than 30 m²/g. These fillers may have been surface-modified by treatment with the various organosilicon compounds conventionally used for this purpose.

Preferably, the filler is silica, and even more preferentially fumed silica. Advantageously, the silica has a BET specific surface area of between 75 m²/g and 410 m²/g.

The silicone composition according to the present invention may also comprise other functional additives which are customary in silicone compositions. As families of customary functional additives, mention may be made of: adhesion promoters, adhesion modulators, consistency-increasing additives, heat resistance additives, additives for resistance to oils or resistance to fire, for example metal oxides, virucides, bactericides, anti-abrasion additives, and pigments (organic or mineral).

However, some customary additives of silicone compositions are not compatible with use for food contact. It is therefore preferable that the silicone composition does not contain any additional additives.

Typically, an adhesion-promoting compound may be an organosilicon compound comprising an adhesion-promoting functional group. In particular, this may be an organosilicon compound comprising:
one or more hydrolyzable groups bonded to the silicon atom, in general alkoxy groups bonded to the silicon atoms, and
one or more organic groups selected from mercaptan groups, the urea group, the isocyanurate group, (meth)acrylate, epoxy and alkenyl radicals.

Mention may for example be made of the following compounds, taken alone or as mixtures: vinyltrimethoxysilane (VTMO), 3-glycidyloxypropyltrimethoxysilane (GLYMO), methacryloxypropyltrimethoxysilane (MEMO), [H₂N(CH₂)₃]Si(OCH₂CH₂CH₃)₃, [H₂N(CH₂)₃]Si(OCH₃)₃, [H₂N(CH₂)₃]Si(OCH₃)₃, [H₂N(CH₂)₃]Si(OCH₃)₃, [H₂NCH₂CH(CH₃)CH₂CH₂]SiCH₃(OCH₃)₂, [H₂NCH₂]Si(OCH₃)₃, [n-C₄H₉—HN—CH₂]Si(OCH₃)₃, [H₂N(CH₂)₂NH(CH₂)₃]Si(OCH₃)₃, H₂N(CH₂)₂NH(CH₂)₃]Si(OCH₂CH₂OCH₃)₃, [CH₃NH(CH₂)₂NH(CH₂)₃]Si(OCH₃)₃, [H(NHCH₂CH₂)₂NH(CH₂)₃]Si(OCH₃)₃, HS(CH₂)₃Si(OCH₃)₃, NH₂CONH₂(CH₂)₃Si(OCH₃), or polyorganosiloxane oligomers, containing for example from 2 to 100 silicon atoms, containing such organic groups at a content of greater than 20%. Mention may also be made specifically of organosilicon compounds comprising at least one, preferably at least two, alkoxy group(s) bonded to a silicon atom and at least one epoxy group.

Furthermore, an adhesion-promoting compound may be an organic titanium compound, preferably a titanium chelate or a metal alkoxide of formula Ti(OR)₄ in which R is selected from linear or branched C₁-C₈alkyl groups, alkoxyalkyl groups, or acyl groups. Even more preferentially, the organic titanium compound is selected from titanium alkoxides such as titanium butoxide, titanium isopropoxide, titanium methoxide and octyl titanate. More preferentially still, the organic titanium compound is titanium butoxide (TBOT).

According to a preferred embodiment, the silicone composition according to the present invention does not contain an adhesion-promoting compound. In particular, the silicone composition according to the present invention preferably does not contain any of the adhesion-promoting compounds mentioned individually above.

Moreover, the silicone composition according to the present invention preferably does not contain an organic solvent, typically does not contain toluene or xylene.

According to a preferred embodiment, the silicone composition which is crosslinkable by a polyaddition reaction according to the invention comprises, based on the total weight of the silicone composition:
from 50% to 95%, preferably from 60% to 90%, of a polyorganosiloxane A having, per molecule, at least two C₂-C₁₂ alkenyl groups bonded to the silicon,
from 0.1% to 20%, preferably from 0.5% to 5%, of a polyorganosiloxane B having, per molecule, at least two SiH units,
from 1 ppm to 400 ppm, preferably from 2 ppm to 200 ppm, of a hydrosilylation catalyst C (calculated by weight of metal),
optionally from 1 ppm to 1000 ppm, preferably from 20 ppm to 500 ppm, of a crosslinking inhibitor D,
optionally from 5% to 40%, preferably from 10% to 30%, of a silica filler.

According to a particular embodiment, the silicone composition which is crosslinkable by a polyaddition reaction according to the invention comprises, based on the total weight of the silicone composition:
from 50% to 95%, preferably from 60% to 90%, of a polyorganosiloxane A having, per molecule, at least two C₂-C₁₂ alkenyl groups bonded to the silicon,
from 0.1% to 20%, preferably from 0.5% to 5%, of a polyorganosiloxane B having, per molecule, at least two SiH units, and a polyorganosiloxane B having a branched structure, such as a silicone resin,
from 1 ppm to 400 ppm, preferably from 2 ppm to 200 ppm, of a hydrosilylation catalyst C (calculated by weight of metal),
optionally from 1 ppm to 1000 ppm, preferably from 20 ppm to 500 ppm, of a crosslinking inhibitor D,
optionally from 5% to 40%, preferably from 10% to 30%, of a silica filler.

The silicone composition which is crosslinkable by a polyaddition reaction according to the invention preferably has a viscosity of greater than 5000 mPa·s, more preferably of between 10 000 mPa·s and 100 000 mPa·s.

According to one embodiment, the silicone composition according to the invention may be prepared from a two-component system which is characterized in that it is in the form of two separate parts which are intended to be mixed in order to form said silicone composition, and in that one of the two parts comprises the catalyst C and does not comprise the polyorganosiloxane B, while the other part comprises the polyorganosiloxane B and does not comprise the catalyst C.

The silicone composition may be prepared by mixing all of the various components as described above. The mixing can be carried out using mixers which are suitable for such compositions, for example kneading mixers or planetary mixers under inert gas atmospheres. Alternatively, the two parts of the composition can be stored in two-component adhesive cartridges, with mixing being provided at the cartridge outlet by a static mixer.

After crosslinking, the silicone composition according to the invention forms a structural silicone adhesive which makes it possible to assemble a plurality of substrates.

The article suitable for food contact according to the present invention comprises a first substrate and a second substrate, these two substrates being joined by the adhesive as described above. The first substrate comprises a support coated with a silicone coating suitable for food contact.

The support is preferably a fibrous support. Among fibrous supports, mention may be made of the various types of paper (such as kraft paper of any beating degree, glassine, greaseproof paper), cardboards, vegetable parchment, papers coated with polyethylene or carboxymethyl cellulose, cellulose sheets. Very preferentially, the support is selected from papers and cardboards. In the case of a paper support, a paper may be selected which preferably has a Bendtsen porosity of between 0.1 ml/min and 500 ml/min according to standard ISO 5636-3 and a COBB value in water of between 5 and 30 according to the ISO 535 method.

Alternatively, the support may be a polymeric material, for example a sheet of polymeric material such as those made of polyethylene, polypropylene, polyethylene terephthalate, or else natural polymers.

Again alternatively, the support may be made of metal, for example a metal sheet.

According to one embodiment, the support according to the present invention is a flexible support. In the present text, “flexible support” means a support which can be bent or folded simply by human strength without breaking or being damaged. In contrast, according to another embodiment, the support according to the present invention is a rigid or semi-rigid support. In the present text, “rigid or semi-rigid support” means a support which cannot be bent or folded easily simply by human strength without breaking or being damaged.

Preferably, the support is in the form of a sheet or a film. However, any other form is possible within the context of the present invention.

According to the present invention, the support of said first substrate is coated with a silicone coating suitable for food contact. The silicone coating may be present on one face of the support, or on both faces. Such coatings are known to those skilled in the art. Typically, the silicone coating suitable for food contact may be obtained by coating the support then crosslinking a silicone composition. Said silicone composition may be a silicone emulsion or a solvent-free silicone composition. For silicone emulsions, reference may particularly be made to European patent application EP 0253747 and international applications WO 99/35181 and WO 2018/178321. For solvent-free silicone compositions, reference may for example be made to international application WO 2005/059039.

Preferably, a suitable silicone coating consists of a water-repellent and non-stick coating or film obtained by coating the support then crosslinking a silicone emulsion. Said silicone emulsion may crosslink by polycondensation chemistry or by polyaddition chemistry. Preferably, said silicone emulsion is an aqueous silicone emulsion which can be crosslinked to give a silicone elastomer by polyaddition reactions. Generally, polyaddition chemistry is preferred for reasons of suitability for food contact, because some tin-based polycondensation catalysts cannot be used. Moreover, without however wishing to be bound by this theory, it is thought that a silicone coating obtained by polyaddition reactions might have residual chemical functions at the surface which are potentially available to serve as anchoring points for the structural silicone adhesive which makes use of the same crosslinking chemistry.

This may in particular be an aqueous silicone emulsion which can be crosslinked to give a silicone elastomer by polyaddition reactions, comprising:
at least one polyorganosiloxane having, per molecule, at least two unsaturated functional groups of the C₂-C₆ alkenyl type bonded to the silicon,
at least one polyorganosiloxane having, per molecule, at least three hydrogen atoms bonded to the silicon,
at least one polyaddition catalyst,
at least one emulsifier,
water,
optionally at least one crosslinking inhibitor,
optionally at least one pH-setting agent, chosen to maintain the pH of the emulsion at between 5 and 9, preferably between 5.5 and 8.5 and more preferentially still between 6 and 8,
optionally at least one formulation additive, for instance a bactericide, for instance sorbic acid, an antifreeze agent and/or wetting agent, for instance glycols such as propylene or ethylene glycol, an antifoaming agent, a filler, preferably a mineral filler, selected from siliceous or non-siliceous materials with siliceous fillers being more particularly preferred, a dye or pigment, an acidifying agent, for instance acetic acid.

However, some customary additives of silicone compositions are not compatible with use for food contact. It is therefore preferable that the silicone composition does not contain any additional additives.

The support coated with a silicone coating according to the present invention, particularly silicone paper, may typically be manufactured by in-line coating, i.e. directly on the machine that manufactures the support, once the sheet has been formed.

The silicone coating preferably has a thickness of between 0.05 g/m² and 1 g/m². However, the amount of silicone emulsion coated onto the support must be adjusted to take into consideration the penetration of the silicone into the support. For example, if the penetration of the silicone into the paper is between 0% and 50% and the paper is coated on both faces thereof, the total amount of silicone per m² of paper is preferably between 0.1 g/m² and 4 g/m².

According to a first embodiment, the second substrate according to the present invention is identical to the first substrate. For example, the first substrate and the second substrate may be a single silicone sheet folded over on itself. The second substrate therefore comprises a support coated with a silicone coating suitable for food contact. The support and the silicone coating may be as described previously for the first substrate. In this configuration, the structural silicone adhesive is preferably inserted between the two substrates and is in contact with the silicone coatings of the two substrates.

According to a second embodiment, the second substrate according to the present invention is different from the first substrate. The second substrate may be a support as described previously, without a silicone coating. For example, the second substrate may be a transparent sheet made of polymeric material. In this configuration, the structural silicone adhesive is preferably inserted between the two substrates and is in contact with the silicone coating of the first substrate, with the second substrate not necessarily having a silicone coating.

The article suitable for food contact according to the invention may be obtained by a method comprising the steps consisting in:
providing a first substrate and a second substrate, the first substrate comprising a support coated with a silicone coating suitable for food contact,
depositing, on the silicone coating of said first substrate, a silicone composition which is crosslinkable by a polyaddition reaction and is suitable for food contact,
joining the second substrate and the first substrate together such that said silicone composition is between the two substrates,
causing or allowing said silicone composition to crosslink in order to adhesively bond the two substrates by a structural silicone adhesive.

The silicone composition which is crosslinkable by a polyaddition reaction and is suitable for food contact may be deposited on the first substrate according to methods known to those skilled in the art. The deposition can take place by pouring, using a brush, using a doctor blade, by immersion or extrusion. According to one embodiment, the silicone composition is deposited continuously over part of the silicone coating of the first substrate. Thus, the silicone coating of the first substrate is covered, for example, with a strip of silicone composition. This embodiment is advantageous if it is desired to obtain continuous and leaktight adhesive bonding between the first and second substrate.

However, it is also possible within the context of the present invention to deposit the silicone composition discontinuously, only over certain areas or for example in dots, when leaktight adhesive bonding is not being sought.

The amount of silicone composition deposited on the silicone coating of the first substrate may be between 1 g/m² and 50 g/m², preferably between 5 g/m² and 20 g/m².

Prior to the deposition of the silicone composition which is crosslinkable by a polyaddition reaction, the method may comprise an optional step of surface treatment of the silicone coating of said first substrate, for example a corona treatment.

The second substrate and the first substrate may be joined together continuously using cylinders and contacting doctor blades.

The silicone composition may crosslink without external intervention if there is sufficient reactivity between the parts brought into contact previously. Nevertheless, it is preferable to thermally activate the crosslinking reaction. Means for thermally activating the crosslinking are conventionally ovens (for example tunnel ovens), heated laminating rollers, or infrared sources. This thermal activation may be supplemented by actinic activation and/or electron bombardment. The crosslinking temperature may be greater than 120° C., without exceeding the breakdown temperature of the support, preferably of between 160° C. and 200° C. The duration of this step of thermal activation of the crosslinking may be between 0.1 s and 30 s, preferably between 0.1 s and 5 s.

Alternatively, the crosslinking reaction may be activated by irradiation, for example by UV. To this end, those skilled in the art may choose a photoactivatable polyaddition catalyst, and optionally suitable photosensitizing additives.

Advantageously, the steps for manufacturing the article suitable for food contact as described above may be carried out continuously, by means of devices known to those skilled in the art, particularly by means of packaging manufacturing machines.

After crosslinking, the final thickness of the structural silicone adhesive may be between 1 μm and 50 μm, preferably between 5 μm and 20 μm.

The article suitable for food contact according to the present invention may advantageously be a food packaging. It may for example be selected from:
flexible packaging: bags and pouches, in particular for leaktight packaging, optionally with the presence of an aeration valve, sandwich bags, bags with or without a transparent window, bloomer bags, etc.,
semi-rigid packaging: boxes, lunchboxes, pastry boxes, hamburger boxes, cases, cones, punnets, pots with or without lids, cups, shells, refill cartons, cartons, etc.
rigid packaging: corrugated cardboard box (of the pizza box type).

The article according to the present invention has properties that make it particularly beneficial for food packaging professionals and for the end consumer:
It is suitable for food contact and meets the relevant regulatory requirements. Silicone, when correctly formulated and used, is known to be non-toxic and inert to food products. In addition, by virtue of using a polyaddition silicone adhesive, the product does not contain any tin-based catalysts.
By virtue of the silicone coating and the silicone adhesive, the article is capable of withstanding large temperature ranges, typically from −30° C. to +250° C. or from −70° C. to +250° C. The article can be used equally for freezing and for cooking. It is particularly suitable for microwave cooking. The article has water barrier properties. It is also non-stick and water-repellent: food does not stick to its packaging, even after storage.
The choice of the structural silicone adhesive makes it possible to assemble the substrates together cohesively and permanently. It is thus possible to produce a leaktight assembly which can be used for the long-term storage of food.
Finally, from the perspective of workability, the article suitable for food contact according to the invention can be manufactured at a high throughput, preferably using standard industrial equipment from the packaging field. The rate of crosslinking of the adhesive is compatible with industrial-level high throughputs. The viscosity of the adhesive is also compatible with industrial deposition equipment. Finally, the adhesive crosslinks without releasing any odor.

Another subject of the invention is the use of a structural silicone adhesive, suitable for food contact and obtained by crosslinking a silicone composition which is crosslinkable by a polyaddition reaction, in order to manufacture an article suitable for food contact.

Other details or advantages of the invention will become apparent in light of the examples given below purely by way of indication.

### Examples

### Manual Coating Tests

A silicone baking parchment of A5 format was manually coated with a silicone composition. A second baking parchment, identical to the first, was manually applied to the coating and the assembly was crosslinked as detailed below.

The silicone compositions tested are as follows:
PSA 1: Silicone PSA consisting of polydimethylsiloxane rubber and MQ(OH) hydroxylated resin in toluene. Dry solids content: 60%. Viscosity: 80 000 mPa·s
PSA 2: Silicone PSA consisting of polydimethylsiloxane rubber and MQ(OH) hydroxylated resin in toluene. Dry solids content: 60%. Viscosity: 70 000 mPa·s
Adhesive 1: RTV2-type silicone composition in 2 parts, that crosslinks by polyaddition.

### Part A:

### Per 100 Parts:

74.38 parts of polydimethylsiloxane oil having Si(CH₃)₂CH═CH₂ ends and a viscosity of 1500 mPa·s
2.11 parts of polyorganosiloxane oils B consisting of a polydimethylsiloxane oil having Si(CH₃)₂H ends and a polymethylhydrogensiloxane oil having Si(CH₃)₃ ends,
23.48 parts of a treated fumed silica, 1
0.03 parts of ethynyl-1-cyclohexanol (ECH).

### Part B:

### Per 100 Parts:

99 parts of polydimethylsiloxane oil having Si(CH₃)₂CH═CH₂ ends and a viscosity of 100 000 mPa·s,
1 part of a Karstedt platinum catalyst (10 ppm relative to the total weight of the composition). Parts A and B are mixed to obtain a ratio of part A to part B equal to 10.

Viscosity of adhesive 1: 40 000 mPa·s.
Adhesive 2 (modification 3): RTV2-type silicone composition in 2 parts, that crosslinks by polyaddition. Part A:

### Per 100 Parts:

75.04 parts of polydimethylsiloxane oil having Si(CH₃)₂CH═CH₂ ends and a viscosity of 1500 mPa·s
1.25 parts of polyorganosiloxanes B consisting of a resin of MM′Q type in which the hydrogen atoms bonded to silicon atoms are borne by the groups M, a polymethylhydrogensiloxane oil having Si(CH₃)₃ ends, and a poly(dimethylsiloxane-co-methylhydrogensiloxane) oil having Si(CH₃)₂H ends,
23.68 parts of treated fumed silica,
0.03 parts of 1-ethynyl-1-cyclohexanol (ECH).

### Part B:

99 parts of polydimethylsiloxane oil having Si(CH₃)₂CH═CH₂ ends and a viscosity of 100 000 mPa·s
1 part of a Karstedt platinum catalyst (10 ppm relative to the total weight of the composition). Parts A and B are mixed to obtain a ratio of part A to part B equal to 10.

Viscosity of adhesive 2:40 000 mPa·s.
Adhesive 3 (modification 7): RTV2-type silicone composition in 2 parts, that crosslinks by polyaddition. Part A:

### Per 100 Parts:

75.06 parts of polydimethylsiloxane oil having Si(CH₃)₂CH═CH₂ ends and a viscosity of 1500 mPa·s
1.22 parts of polyorganosiloxane oils B consisting of polymethylhydrogensiloxane oil having Si(CH₃)₃ ends and a poly(dimethylsiloxane-co-methylhydrogensiloxane) oil having Si(CH₃)₂H ends.
23.69 parts of treated fumed silica,
0.03 parts of 1-ethynyl-1-cyclohexanol (ECH).

### Part B:

### Per 100 Parts:

99 parts of polydimethylsiloxane oil having Si(CH₃)₂CH═CH₂ ends and a viscosity of 100 000 mPa·s,
1 part of a Karstedt platinum catalyst (10 ppm relative to the total weight of the composition).

Parts A and B are mixed to obtain a ratio of part A to part B equal to 10.

Viscosity of adhesive 3:40 000 mPa·s.
Adhesive 4 (comparative): RTV2-type silicone composition in 2 parts, that crosslinks by polyaddition.
Part A: polydimethylsiloxane oils having Si(CH₃)₂CH═CH₂ ends, polydimethylsiloxane oil having Si(CH₃): H ends, poly(methylhydrogensiloxane-co-dimethylsiloxane) oil having Si(CH₃)₃ ends, treated fumed silica, 1-ethynyl-1-cyclohexanol (ECH), 3-glycidyloxypropyltrimethoxysilane (GLYMO).
Part B: polydimethylsiloxane oils having Si(CH₃)₂CH═CH₂ ends, treated fumed silica, Karstedt platinum catalyst (10 ppm relative to the total weight of the composition), titanium butoxide (TBOT).

Parts A and B are mixed to obtain a ratio of part A to part B equal to 10. Viscosity of adhesive 4:40 000 mPa·s.

This composition is unsuitable for food contact due to the presence of adhesion promoters such as 3-glycidyloxypropyltrimethoxysilane (GLYMO) or titanium butoxide (TBOT).
Adhesive 5 (comparative): RTV1-type silicone composition in 1 part, that crosslinks by polycondensation.
Formulation: Polydimethylsiloxane oils having hydroxy ends, treated fumed silica, methyltriacetoxysilane, tetra-n-butyl titanate (polycondensation catalyst).

The adhesion quality was evaluated on a dynamometer using a T peel test method inspired by standard ASTM D1876. Particular attention was paid to the rupture characteristics of the test specimens; this absolutely had to be cohesive (tearing of the paper during the test) in order to ensure optimum performance of the assembly.

The results are reported in table 1 below:

| Silicone | | | | | Suitable |
|---|---|---|---|---|---|
| composition | Thickness | Type of | Rupture | | for food |
| coated | (μm) | heating | characteristics | Comments | contact? |
| PSA 1 | 20 | None | Adhesive | Low adhesion | Yes |
| PSA 1 | 50 | None | Adhesive | Low adhesion | Yes |
| PSA 2 | 20 | None | Adhesive | Low adhesion | Yes |
| PSA 2 | 50 | None | Adhesive | Low adhesion | Yes |
| Adhesive 1 | 100 | Heated metal | Cohesive | Breakage of | Yes |
| | | cylinders | | paper, no odor | |
| Adhesive 2 | 20 | IR lamps | Cohesive | Breakage of | Yes |
| | | | | paper, no odor | |
| Adhesive 3 | 20 | IR lamps | Cohesive | Breakage of | Yes |
| | | | | paper, no odor | |
| Adhesive 4 | 100 | Heated metal | Cohesive | Breakage of | No |
| (comparative) | | cylinders | | paper, no odor | |
| Adhesive 5 | 100 | Heated metal | Cohesive | Strong acetic | Yes |
| (comparative) | | cylinders | | acid odor | |

The results obtained with the PSA-type compositions are inconclusive and significantly poorer than for structural adhesives. The adhesives of the present invention 1, 2 and 3, which are each a silicone composition that crosslinks by polyaddition, make it possible to achieve satisfactory adhesion while also being suitable for food contact and not having any major disadvantages in terms of ability to be formed (for example odor).

Unlike the comparative example (adhesive 4), the adhesives of the present invention (1, 2 and 3) do not require the presence of an adhesion promoter to achieve satisfactory adhesion results. Moreover, comparative example 5 is an adhesive that crosslinked by polycondensation and thus has the disadvantage of releasing acetic acid.

Furthermore, adhesives 2 and 3 of the present invention lead to satisfactory results despite the low thickness of adhesive coated. Thus, these embodiments are particularly advantageous on an industrial scale.

### Cylinder Coating Test

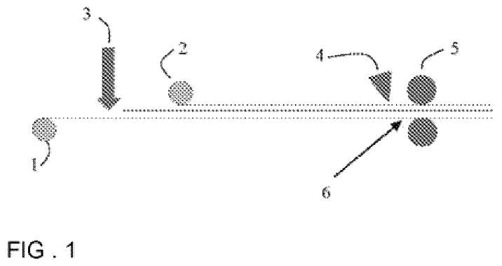

A coating tool having two cylinders and a heated doctor blade was used. This tool is depicted in FIG. 1: a first substrate (1) and a second substrate (2) were attached to cylinders. An adhesive composition was applied using a deposition means (3). A heated metal doctor blade (4) was brought into contact with the second support, before the assembly passed between 2 heated metal lamination cylinders (5). The gap (6) between the two cylinders was set at 0.1 mm. Passage into the tool was manual and estimated to be approximately 10 m/min. The target temperature of the doctor blade and the two metal cylinders was controlled electronically.
Substrate: Commercial silicone-coated baking parchment

Composition of the silicone adhesive: as described above for adhesive 1.

Crosslinking is evaluated visually by the scissor blade fouling test: Just after crosslinking, a cutting test is performed using a paper cutter or scissors in order to assess the fouling of the blade. The blade of the cutting tool must not be fouled and must remain clear of silicone.

Adhesion is evaluated manually: Just after crosslinking, the two parts of the assembly are held firmly during a shear test. The assembly must be able to withstand the stresses applied by the production tool.

The results are presented in table 2 below:

TABLE 2

| Target temperature | Visual evaluation | Manual evaluation |
|---|---|---|
| of tool (° C.) | of crosslinking | of adhesion |
| 200 | OK | OK |
| 220 | OK | OK |

The assemblies obtained as described previously were placed in a cold environment (−17° C.) in a food freezer for 2 h, then were removed and immediately mechanically tested. Other assemblies were placed in a hot environment (+230° C.) in a laboratory oven for 2 h, then were removed and immediately mechanically tested. In both cases, preservation of the mechanical performance of the assembly was observed.

1. An article suitable for food contact, said article comprising a first substrate and a second substrate which are joined by an adhesive, said first substrate comprising a support coated with a silicone coating suitable for food contact, said adhesive being inserted between the two substrates and being in contact with the silicone coating of said first substrate, wherein said adhesive is a structural silicone adhesive suitable for food contact and obtained by crosslinking a silicone composition which is crosslinkable by a polyaddition reaction.

2. The article as claimed in claim 1, wherein the silicone composition which is crosslinkable by a polyaddition reaction comprises:
at least one polyorganosiloxane A having, per molecule, at least two C₂-C₁₂ alkenyl groups bonded to the silicon,
at least one polyorganosiloxane B having, per molecule, at least two SiH units,
a catalytically effective amount of at least one polyaddition catalyst C, optionally a platinum-based polyaddition catalyst, and
optionally at least one crosslinking inhibitor D.

3. The article as claimed in claim 1, wherein the silicone composition which is crosslinkable by a polyaddition reaction comprises between 5% and 40% by weight of filler relative to the total weight of the silicone composition.

4. The article as claimed in claim 1, wherein the silicone composition does not contain any organic solvent, typically and optionally does not contain toluene or xylene.

5. The article as claimed in claim 1, wherein the silicone composition which is crosslinkable by a polyaddition reaction has a viscosity of greater than 5000 mPa·s, optionally between 10 000 mPa·s and 100 000 mPa·s.

6. The article as claimed in claim 1, wherein the support is a fibrous support; optionally, the support is selected from paper and/or cardboard.

7. The article as claimed in claim 1, wherein the silicone coating suitable for food contact comprises or consists of a water-repellent and non-stick coating or film obtained by coating the support then crosslinking a silicone emulsion, optionally an aqueous silicone emulsion which can be crosslinked to give a silicone elastomer by a polyaddition reaction.

8. The article as claimed in claim 1, wherein said article is a food packaging, optionally selected from:
flexible packaging optionally one or more of bags and pouches, optionally for leaktight packaging, optionally with the presence of an aeration valve, sandwich bags, bags with or without a transparent window, and/or bloomer bags
semi-rigid packaging optionally one or more of boxes, lunchboxes, pastry boxes, hamburger boxes, cases, cones, punnets, pots with or without lids, cups, shells, refill cartons, and/or cartons
rigid packaging optionally a corrugated cardboard box optionally a pizza box type.

9. A method for manufacturing an article suitable for food contact, said method comprising:
providing a first substrate and a second substrate, the first substrate comprising a support coated with a silicone coating suitable for food contact,
depositing, on the silicone coating of said first substrate, a silicone composition which is crosslinkable by a polyaddition reaction and is suitable for food contact,
joining the second substrate and the first substrate together such that said silicone composition is between the two substrates,
causing or allowing said silicone composition to crosslink in order to adhesively bond the two substrates by a structural silicone adhesive.

10. An article comprising a structural silicone adhesive, suitable for food contact and obtained by crosslinking a silicone composition which is crosslinkable by a polyaddition reaction, wherein said article is suitable for food contact.
